(19) United States
(12) Patent Application Publication
(10) Pub. No.: US 2025/0056445 A1
(43) Pub. Date: Feb. 13, 2025

(54) DEVICES, METHODS, APPARATUSES, AND COMPUTER READABLE MEDIA FOR SYNCHRONIZATION SIGNAL BLOCK MEASUREMENT

(71) Applicant: Nokia Technologies Oy, Espoo (FI)

(72) Inventors: Lei DU, Beijing (CN); Chunli WU, Beijing (CN); Naizheng ZHENG, Beijing (CN); Lars DALSGAARD, Oulu (FI)

(21) Appl. No.: 18/773,041

(22) Filed: Jul. 15, 2024

(30) Foreign Application Priority Data
Aug. 7, 2023 (WO) PCT/CN2023/111478

(51) Int. Cl. H04W 56/00; H04W 76/28

(52) U.S. Cl. CPC H04W 56/0015; H04W 56/0065; H04W 76/28

(57) ABSTRACT

Disclosed are devices, methods, apparatuses, and computer readable media for synchronization signal block measurement. An example apparatus for a terminal device may include at least one processor and at least one memory. The at least one memory may store instructions that, when executed by the at least one processor, may cause the terminal device at least to: receive, from a network device serving the terminal device, a configuration for discontinuous transmission defining an active period and a non-active period of a cell associated with the network device; determine whether to perform a synchronization signal block measurement during the non-active period based on a first condition and a second condition different from the first condition; based on said determining, if the first condition is satisfied, perform the synchronization signal block measurement during the non-active period; and based on said determining, if the second condition is satisfied, refrain from performing the synchronization signal block measurement during the non-active period.

### TECHNICAL FIELD

Various example embodiments relate to devices, methods, apparatuses, and computer readable media for synchronization signal block (SSB) measurement.

### BACKGROUND

The SSB may also refer to a synchronization signal and physical broadcast channel (PBCH) block. In the present disclosure, the term SSB or synchronization signal block may also refer to the synchronization signal and PBCH block. SSB measurement (also referred to as SSB based measurement) may be the basis for data transmission of a user equipment (UE). If a UE does not perform the SSB measurement for a long time, e.g. several seconds, the UE may lose the connection with the cell, and in this case UE would need more time for cell detection before starting the data transmission. On network (NW) side, cell discontinuous transmission (DTX), cell discontinuous reception (DRX), etc. have been introduced for network energy saving (NES). A cell DTX/DRX configuration defines an active period and a non-active (also referred to as an inactive) period of a cell, and the data transmission is not expected during the non-active period of the cell DTX unless some exceptional cases are specified. So, during the non-active period of the cell DTX, if the UE wakes up to perform the SSB measurement, the SSB measurement may be a waste of energy on the UE.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is an apparatus for a terminal device. The apparatus may include at least one processor and at least one memory. The at least one memory may store instructions that, when executed by the at least one processor, may cause the terminal device at least to: receive, from a network device serving the terminal device, a configuration for discontinuous transmission defining an active period and a non-active period of a cell associated with the network device; determine whether to perform a synchronization signal block measurement during the non-active period based on a first condition and a second condition different from the first condition; based on said determining, if the first condition is satisfied, perform the synchronization signal block measurement during the non-active period; and based on said determining, if the second condition is satisfied, refrain from performing the synchronization signal block measurement during the non-active period.

In a second aspect, disclosed is an apparatus for a network device. The apparatus may include at least one processor and at least one memory. The at least one memory may store instructions that, when executed by the at least one processor, may cause the network device at least to: transmit to a terminal device being served by the network device, a configuration for discontinuous transmission defining an active period and a non-active period of a cell associated with the network device; transmit a synchronization signal block during the non-active period and the active period of the cell; receive from the terminal device a first measurement report based on a synchronization signal block measurement during the non-active period and the active period on the synchronization signal block, in case of determining a first condition is satisfied; and receive from the terminal device a second measurement report based on the synchronization signal block measurement during the active period on the synchronization signal block, in case of determining a second condition different from the first condition is satisfied.

In a third aspect, disclosed is a method performed by an apparatus for a terminal device. The method may comprise: receiving, from a network device serving the terminal device, a configuration for discontinuous transmission defining an active period and a non-active period of a cell associated with the network device; determining whether to perform a synchronization signal block measurement during the non-active period based on a first condition and a second condition different from the first condition; based on said determining, if the first condition is satisfied, performing the synchronization signal block measurement during the non-active period; and based on said determining, if the second condition is satisfied, refraining from performing the synchronization signal block measurement during the non-active period.

In a fourth aspect, disclosed is a method performed by an apparatus for a network device. The method may comprise: transmitting to a terminal device being served by the network device, a configuration for discontinuous transmission defining an active period and a non-active period of a cell associated with the network device; transmitting a synchronization signal block during the non-active period and the active period of the cell; receiving from the terminal device a first measurement report based on a synchronization signal block measurement during the non-active period and the active period on the synchronization signal block, in case of determining a first condition is satisfied; and receiving from the terminal device a second measurement report based on the synchronization signal block measurement during the active period on the synchronization signal block, in case of determining a second condition different from the first condition is satisfied.

In a fifth aspect, disclosed is an apparatus for a terminal device. The apparatus for the terminal device may comprise: means for receiving, from a network device serving the terminal device, a configuration for discontinuous transmission defining an active period and a non-active period of a cell associated with the network device; means for determining whether to perform a synchronization signal block measurement during the non-active period based on a first condition and a second condition different from the first condition; means for based on said determining, if the first condition is satisfied, performing the synchronization signal block measurement during the non-active period; and means for based on said determining, if the second condition is satisfied, refraining from performing the synchronization signal block measurement during the non-active period.

In a sixth aspect, disclosed is an apparatus for a network device. The apparatus for the network device may comprise: means for transmitting to a terminal device being served by the network device, a configuration for discontinuous transmission defining an active period and a non-active period of a cell associated with the network device; means for transmitting a synchronization signal block during the non-active period and the active period of the cell; means for receiving from the terminal device a first measurement report based on a synchronization signal block measurement during the non-active period and the active period on the synchronization signal block, in case of determining a first condition is satisfied; and means for receiving from the terminal device a second measurement report based on the synchronization signal block measurement during the active period on the synchronization signal block, in case of determining a second condition different from the first condition is satisfied.

In a seventh aspect, a computer readable medium is disclosed. The computer readable medium may comprise program instructions that, when executed by an apparatus for a terminal device, may cause the terminal device at least to perform: receiving, from a network device serving the terminal device, a configuration for discontinuous transmission defining an active period and a non-active period of a cell associated with the network device; determining whether to perform a synchronization signal block measurement during the non-active period based on a first condition and a second condition different from the first condition; based on said determining, if the first condition is satisfied, performing the synchronization signal block measurement during the non-active period; and based on said determining, if the second condition is satisfied, refraining from performing the synchronization signal block measurement during the non-active period.

In an eighth aspect, a computer readable medium is disclosed. The computer readable medium may comprise program instructions that, when executed by an apparatus for a network device, cause the network device at least to perform: transmitting to a terminal device being served by the network device, a configuration for discontinuous transmission defining an active period and a non-active period of a cell associated with the network device; transmitting a synchronization signal block during the non-active period and the active period of the cell; receiving from the terminal device a first measurement report based on a synchronization signal block measurement during the non-active period and the active period on the synchronization signal block, in case of determining a first condition is satisfied; and receiving from the terminal device a second measurement report based on the synchronization signal block measurement during the active period on the synchronization signal block, in case of determining a second condition different from the first condition is satisfied.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an overall exemplary sequence diagram for SSB measurement according to the example embodiments of the present disclosure.

FIG. 2A shows an exemplary sequence diagram for SSB measurement according to the example embodiments of the present disclosure.

FIG. 2B shows an exemplary sequence diagram for SSB measurement according to the example embodiments of the present disclosure.

FIG. 3 shows a flow chart illustrating an example method 300 for SSB measurement according to the example embodiments of the present disclosure.

FIG. 4 shows a flow chart illustrating an example method 400 for SSB measurement according to the example embodiments of the present disclosure.

FIG. 5 shows a block diagram illustrating an example device 500 for SSB measurement according to the example embodiments of the present disclosure.

FIG. 6 shows a block diagram illustrating an example device 600 for SSB measurement according to the example embodiments of the present disclosure.

FIG. 7 shows a block diagram illustrating an example apparatus 700 for SSB measurement according to the example embodiments of the present disclosure.

FIG. 8 shows a block diagram illustrating an example apparatus 800 for SSB measurement according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution for the SSB measurement. According to the example embodiments of the present disclosure, the UE may perform the SSB measurement during the cell DTX non-active period when necessary, such that the UE power saving may be maximized without sacrificing the measurement performance.

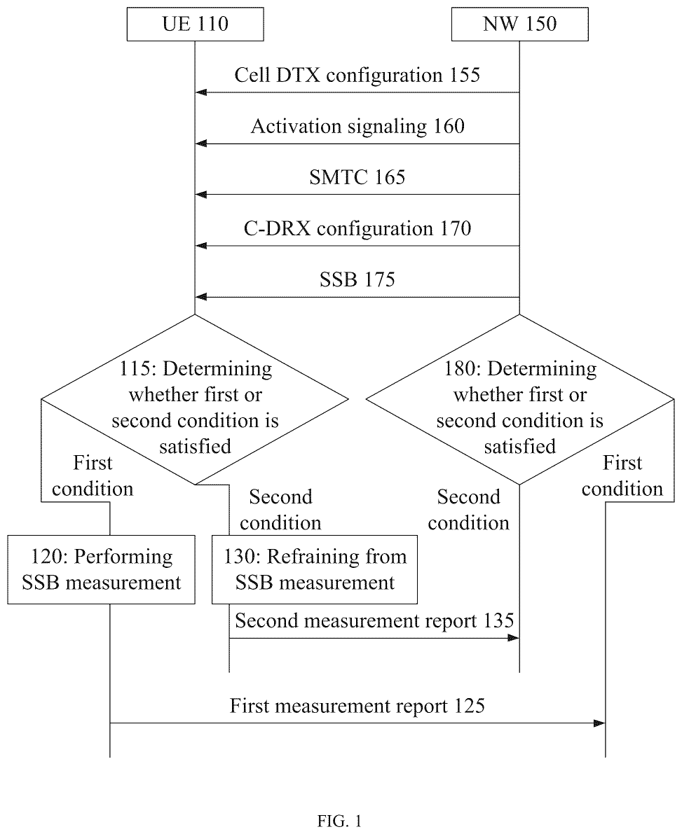

FIG. 1 shows an overall exemplary sequence diagram for SSB measurement according to the example embodiments of the present disclosure. Referring to the FIG. 1, a UE 110 may represent any terminal device in a wireless network. A network device 150 may represent the network side of the wireless network. The network device 150 may be associated with a cell serving the UE 110. The UE 110 may be in a radio resource control (RRC) connected mode.

The network device 150 may configure a DTX defining an active period and a non-active period on the cell serving the UE 110. Then, the network device 150 may transmit the cell DTX configuration 155 to the UE 110. In some embodiments, the cell DTX configuration 155 may be transmitted via a RRC reconfiguration. In some embodiments, the cell DTX is not activated when being configured, and in this case, the network device 150 may activate the cell DTX on the cell and may additionally transmit to the UE 110 an activation signaling 160 to activate the cell DTX configuration 155. The activation signaling 160 may inform the UE 110 the activation of the cell DTX configuration 155. In some embodiments, the activation signaling 160 may be transmitted via a downlink control information (DCI) or medium access control (MAC) based indication. The activation signaling 160 may be transmitted in a different, e.g. later, message than the message(s) delivering the cell DTX configuration 155. After the cell DTX configuration 155 is activated, the cell may alternately enter the active period and the non-active period defined by the cell DTX configuration 155, and the UE 110 may be aware the active period and the non-active period of the cell.

In some embodiments, the network device 150 may configure a SSB-based measurement timing configuration (SMTC) 165 for the UE 110 and transmit the SMTC 165 to the UE 110. The SMTC 165 may be transmitted via e.g. the RRC reconfiguration. Alternatively, the SMTC 165 may be predefined in a standard. The SMTC 165 may include parameters used for the UE 110 to determine whether and how to perform the SSB measurement when the cell DTX is not configured or activated. Alternatively or additionally, the SMTC 165 may define periodicity for the SSB measurement at least during the cell DTX active period.

Additionally, in some embodiments, the network device 150 may configure a connected discontinuous reception (c-DRX) for the UE 110 and transmit the c-DRX configuration 170 to the UE 110. The c-DRX may be understood as the DRX for the UE 110 in a connected mode, e.g. RRC_Connected. The c-DRX configuration 170 may be transmitted via e.g. the RRC reconfiguration. The c-DRX configuration 170 is for UE power saving and may include parameters used for the UE 110 to determine whether and when to wake up to monitor physical downlink control channel (PDCCH).

During both the active period and the non-active period of the cell, the network device 150 may transmit to the UE 110 a SSB 175 according to certain SSB transmission periodicity. For the SSB 175 during the active period, the UE 110 may perform the SSB measurement during the active period based on the SMTC 165. For the SSB 175 during the non-active period, in an operation 115, the UE 110 may determine whether to perform the SSB measurement during the non-active period based on a first condition and a second condition different from the first condition. If the first condition is determined to be satisfied (“First condition” prong of the operation 115), in an operation 120, the UE 110 may perform the SSB measurement during the non-active period on the SSB 175. If the second condition is determined to be satisfied (“Second condition” prong of the operation 115), in an operation 130, the UE 110 may refrain from performing the SSB measurement during the non-active period on the SSB 175.

In some embodiments, the UE 110 may take both the c-DRX configuration 170 and the cell DTX configuration 155 into account for SSB measurement and performs the SSB measurement e.g. during both the c-DRX active time and the cell DTX active time. If the periodicity of the c-DRX is denoted as c-DRX cycle, the periodicity of the SSB measurement is denoted as SMTC cycle, and the periodicity of the cell DTX is denoted as cell DTX cycle, the UE 110 shall wake up to measure the SSB 175 based on max (SMTC cycle, c-DRX cycle, cell DTX cycle) when the c-DRX of the UE 110 is in use, or max (SMTC cycle, cell DTX cycle) if the c-DRX of the UE 110 is not configured.

On the network side, in an operation 180, the network device 150 may also determine whether the first condition or the second condition is satisfied, such that the network device 150 may be aware whether and how the UE 110 performs the SSB measurement during the non-active period.

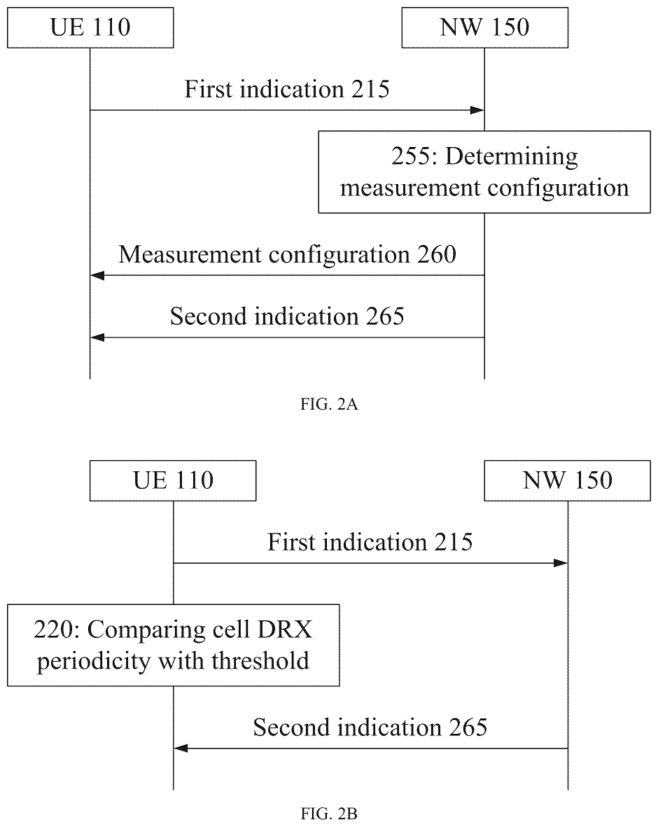

FIG. 2A shows an exemplary sequence diagram for SSB measurement according to the example embodiments of the present disclosure. The exemplary sequence shown in the FIG. 2A may be performed by the UE 110 and the network device 150 and may lead to the satisfaction of the first condition.

In some embodiments, the UE 110 transmits to the network device 150, a first indication 215 indicating whether or not the UE 110 has capability to support the SSB measurement during the non-active period or has preference to measure SSB during the non-active period. The first indication 215 is optional. In some embodiments, the absence of the first indication 215 may implicitly indicate the UE has capability to support the SSB measurement during the non-active period and the UE 110 sends the first indication 215 only when it does not have the capability to support the SSB measurement during the non-active period or vice versa. In this case, without the first indication 215, the network device 150 may assume that the UE 110 has capability to support the SSB measurement or has preference to measure SSB during the non-active period. Alternatively, the network device may interpret the lack of the first indication 215 as incapability for the SSB measurement during the non-active period.

In a case where the first indication 215 indicates that the UE 110 has capability to support the SSB measurement or has preference to measure SSB during the non-active period, in some embodiments, for the UE 110 the first condition is satisfied in case of such first indication 215. Receiving such first indication 215, the network device 150 may also determine that for the UE 110 the first condition is satisfied and assume that the UE 110 would perform the SSB measurement during the non-active period.

Referring back to the FIG. 1, in this case, in some embodiments, in the operation 120 the UE 110 may perform the SSB measurement during the non-active period according to a periodicity of the SSB measurement. The periodicity of the SSB measurement may be a parameter in the SMTC 165. On the network side the network device 150 may refrain from determining a measurement configuration for the UE 110 to perform the SSB measurement during the non-active period.

Based on the SSB measurement during the non-active period and the active period according to the SMTC 165, the UE 110 may derive a first measurement report 125 and transmit the first measurement report 125 to the network device 150. In this case, the first measurement report 125 received by the network device 150 is based on the SSB measurement during the non-active period and the active period performed on the SSB 175 according to the SMTC 165.

Alternatively, referring to the FIG. 2A, in some embodiments, in a case where the first indication 215 indicates that the UE 110 has capability to support the SSB measurement or has preference to measure SSB during the non-active period, receiving such first indication 215, in an operation 255, the network device 150 may determine a measurement configuration 260 for the UE 110 to perform the SSB measurement during the non-active period according to the measurement configuration 260. The measurement configuration 260 may be dedicated for the UE 110 or common to a plurality of UEs including the UE 110. Then, the network device 150 may transmit to the UE 110 the measurement configuration 260 to make the first condition satisfied. In this case, referring back to the FIG. 1, in the operation 120, the UE 110 may perform the SSB measurement during the non-active period according to the measurement configuration 260.

In some embodiments, the measurement configuration 260 may include a measurement periodicity and a measurement window, and in the operation 120, the UE 110 may perform the SSB measurement during the non-active period according to the measurement periodicity and within the measurement window. The measurement periodicity may be longer than the periodicity for perform the SSB measurement during the active period, such that the SSB measurement during the non-active period may be infrequent compared with that during the active period.

Alternatively, in some embodiments, the measurement configuration 260 may be a measurement configuration of a deactivated secondary cell (SCell). For example, in the operation 120, the UE 110 may reuse the measurement configuration of a deactivated SCell if configured, e.g. performing the SSB measurement during the non-active period according to the measCycleSCell.

Alternatively, in some embodiments, the measurement configuration 260 may include a scaling factor, and in the operation 120 the UE 110 may perform the SSB measurement during the non-active period according to the scaling factor multiplied by the periodicity of the SSB measurement or by the larger between a periodicity of the c-DRX of the UE 110 and the periodicity of the SSB measurement. The periodicity of the c-DRX may be a parameter in the c-DRX configuration 170, and the periodicity of the SSB measurement may be a parameter in the SMTC 165.

If the scaling factor is denoted as k, the periodicity of the c-DRX is denoted as c-DRX cycle, and the periodicity of the SSB measurement is denoted as SMTC cycle, the UE 110 may perform the SSB measurement during the non-active period according to k*SMTC cycle or k*max (c-DRX cycle, SMTC cycle).

In the above cases where the measurement configuration 260 is available for the UE 110, the SSB measurement during the non-active period may be performed according to the measurement configuration 260, and in this case the first measurement report 125 received by the network device 150 is based on the SSB measurement during the non-active period and the active period on the SSB 175.

FIG. 2B shows an exemplary sequence diagram for SSB measurement according to the example embodiments of the present disclosure. The exemplary sequence shown in the FIG. 2B may be performed by the UE 110 and the network device 150 and may lead to the satisfaction of the second condition.

For example, referring to the FIG. 2B, if the first indication 215 indicates that the UE 110 has no capability to support the SSB measurement during the non-active period, the UE 110 would not perform the SSB measurement during the non-active period, and receiving such first indication 215 the network device 150 may determine that for the UE 110 the second condition is satisfied and/or the UE 110 would not perform the SSB measurement during the non-active period.

In some embodiments, in an operation 220, the UE 110 may compare a periodicity of the cell DTX with a threshold, and in the operation 115 shown in the FIG. 1, the UE 110 may determine the second condition is satisfied in a case where the periodicity of the cell DTX is equal to or smaller than the threshold. For example, the cell DTX configuration 155 may include parameters used for the cell DTX, and the parameters may include the periodicity of the cell DTX. Satisfying the second condition means the cell may be kept detectable even if the UE 110 does not perform the SSB measurement during the non-active period. Otherwise, the UE 110 shall wake up and measure at least one SSB to keep the cell detected.

In some embodiments, the threshold may be predefined according to a time period for identifying a cell. For example, the time period may be equal to the time to identify the cell, such as T_{identify_intra_without_index} of the standard specifications.

Alternatively, in some embodiments, referring back to the FIG. 1, the UE 110 receives the c-DRX configuration 170 or both the c-DRX configuration 170 and the SMTC 165 from the network device 150, the c-DRX configuration 170 includes the periodicity of the c-DRX, and the SMTC 165 includes the periodicity of the SSB measurement. In this case, the threshold may be a number of the periodicity of the SSB measurement, or a number of the larger between the periodicity of the c-DRX and the periodicity of the SSB measurement.

If the number is denotes as N, the periodicity of the c-DRX is denoted as c-DRX cycle, and the periodicity of the SSB measurement is denoted as SMTC cycle, the threshold may be expressed as N*SMTC cycle or N*max (SMTC cycle, c-DRX cycle).

Referring back to the FIG. 1, if the second condition is determined to be satisfied in the operation 115, in the operation 130, the UE 110 may refrain from performing the SSB measurement during the non-active period. In this case, the UE 110 may derive a second measurement report 135 and transmit the second measurement report 135 to the network device 150. In this case, the second measurement report 135 received by the network device 150 is based on the SSB measurement during the active period on the SSB 175 since no SSB measurement is performed during the non-active period.

Referring to both the FIG. 2A and the FIG. 2B, in some embodiments, the network device 150 may transmit to the UE 110, a second indication 265 indicating whether the UE 110 performs the SSB measurement during at least one following non-active period. The number of the at least one following non-active period may be predefined in a standard or determined by the network device 150 and included in the second indication 265. During the at least one following non-active period, whether the first condition or the second condition is satisfied may depend on the second indication 265.

In a case where the second indication 265 indicates the UE 110 not to perform the SSB measurement during the at least one following non-active period, referring back to the FIG. 1, in the operation 115, the second condition is determined to be satisfied and the UE 110 may determine not to perform the SSB measurement during the at least one following non-active period. And in this case the second measurement report 135 may be based on the SSB measurement during the active period.

Alternatively, in a case where the second indication 265 indicates the UE 110 to perform the SSB measurement during the at least one following non-active period, in the operation 115, the first condition is determined to be satisfied and the UE 110 may determine to perform the SSB measurement during the at least one following non-active period. And in this case the first measurement report 125 may be based on the SSB measurement during the active period and the non-active period.

The second indication 265 may be transmitted via, e.g. DCI, MAC or RRC message, and a dynamic network control may be realized based on the second indication 265.

According to the example embodiments of the present disclosure, the SSB measurement during the non-active period of cell DTX may be reduced so as to benefit UE power saving, while the impact on system performance with consistent and qualified measurement performance may also be reduced.

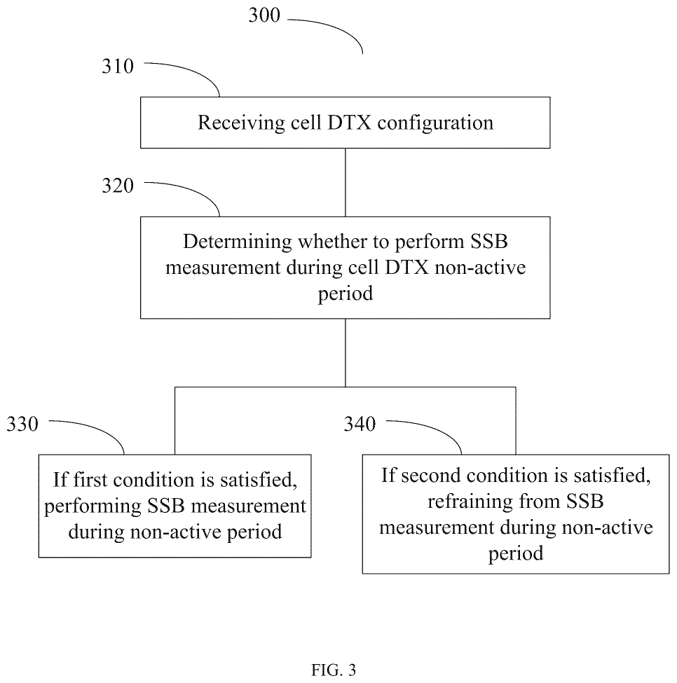

FIG. 3 shows a flow chart illustrating an example method 300 for SSB measurement according to the example embodiments of the present disclosure. The example method 300 may be performed for example by an apparatus for a terminal device such as the UE 110 above mentioned.

Referring to the FIG. 3, the example method 300 may comprise: an operation 310 of receiving, from a network device serving the terminal device, a configuration for DTX defining an active period and a non-active period of a cell associated with the network device; an operation 320 of determining whether to perform a SSB measurement during the non-active period based on a first condition and a second condition different from the first condition; an operation 330 of based on said determining, if the first condition is satisfied, performing the SSB measurement during the non-active period; and an operation 340 of based on said determining, if the second condition is satisfied, refraining from performing the SSB measurement during the non-active period.

Details of the operation 310 have been described in the above descriptions with respect to at least the cell DTX configuration 155, and repetitive descriptions thereof are omitted here.

Details of the operation 320 have been described in the above descriptions with respect to at least the operation 115, and repetitive descriptions thereof are omitted here.

Details of the operation 330 have been described in the above descriptions with respect to at least the operation 120, and repetitive descriptions thereof are omitted here.

Details of the operation 340 have been described in the above descriptions with respect to at least the operation 130, and repetitive descriptions thereof are omitted here.

In some embodiments, the example method 300 may include an operation of receiving from the network device, an activation signaling to activate the configuration for the DTX. The more details have been described in the above descriptions with respect to at least the activation signaling 160, and repetitive descriptions thereof are omitted here.

In some embodiments, the configuration for the DTX may comprise parameters used for the DTX, the parameters may comprise a periodicity of the DTX, and wherein the apparatus may be configured to: compare the periodicity of the DTX with a threshold, and the second condition may be satisfied in a case where the periodicity of the DTX is equal to or smaller than the threshold. The more details have been described in the above descriptions with respect to at least the cell DTX configuration 155, the operation 220 and the operation 115, and repetitive descriptions thereof are omitted here.

In some embodiments, the threshold may be predefined according to a time period for identifying a cell. The more details have been described in the above descriptions with respect to at least the operation 220, and repetitive descriptions thereof are omitted here.

In some embodiments, the apparatus may be configured to receive from the network device, a SMTC, or the SMTC and a configuration for c-DRX of the terminal device, and the configuration for the c-DRX may comprise a periodicity of the c-DRX, the SMTC may comprise a periodicity of the SSB measurement, and the threshold may be a number of the periodicity of the SSB measurement, or a number of the larger between the periodicity of the c-DRX and the periodicity of the SSB measurement. The more details have been described in the above descriptions with respect to at least the SMTC 165, the c-DRX configuration 170, the operation 220 and the operation 115, and repetitive descriptions thereof are omitted here.

In some embodiments, the first condition may be satisfied in case of receiving a measurement configuration from the network device, and the apparatus may be configured to perform the SSB measurement during the non-active period according to the measurement configuration. The more details have been described in the above descriptions with respect to at least the measurement configuration 260, and repetitive descriptions thereof are omitted here.

In some embodiments, the measurement configuration may comprise a measurement periodicity and a measurement window, and the SSB measurement during the non-active period may be performed according to the measurement periodicity and within the measurement window. The more details have been described in the above descriptions with respect to at least the measurement configuration 260 and the operation 120, and repetitive descriptions thereof are omitted here.

In some embodiments, the measurement configuration may be a measurement configuration of a deactivated SCell. The more details have been described in the above descriptions with respect to at least the measurement configuration 260, and repetitive descriptions thereof are omitted here.

In some embodiments, the measurement configuration may comprise a scaling factor, and the SSB measurement during the non-active period may be performed according to the scaling factor multiplied by a periodicity of the SSB measurement or by the larger between a periodicity of a c-DRX of the terminal device and the periodicity of the SSB measurement. The more details have been described in the above descriptions with respect to at least the SMTC 165, the c-DRX configuration 170, the measurement configuration 260 and the operation 120, and repetitive descriptions thereof are omitted here.

In some embodiments, the apparatus may be configured to: transmit to the network device, a first indication indicating whether the terminal device has capability to support the SSB measurement during the non-active period. The more details have been described in the above descriptions with respect to at least the first indication 215, and repetitive descriptions thereof are omitted here.

In some embodiments, the measurement configuration may be received in a case where the first indication indicates that the terminal device has capability to support the SSB measurement during the non-active period. The more details have been described in the above descriptions with respect to at least the first indication 215 and the measurement configuration 260, and repetitive descriptions thereof are omitted here.

In some embodiments, the apparatus may be configured to transmit to the network device, a first indication indicating whether the terminal device has capability to support the SSB measurement during the non-active period, the first condition may be satisfied in a case where the first indication indicates that the terminal device has capability to support the SSB measurement during the non-active period, and the apparatus may be configured to perform the SSB measurement during the non-active period according to a SMTC. The more details have been described in the above descriptions with respect to at least the first indication 215, the SMTC 165 and the operation 120, and repetitive descriptions thereof are omitted here.

In some embodiments, the apparatus may be configured to receive from the network device, a second indication indicating whether the terminal device performs the SSB measurement during at least one following non-active period, and performing the SSB measurement during the at least one following non-active period may be determined in a case where the second indication indicates the terminal device to perform the SSB during the at least one following non-active period. The more details have been described in the above descriptions with respect to at least the second indication 265 and the operation 120, and repetitive descriptions thereof are omitted here.

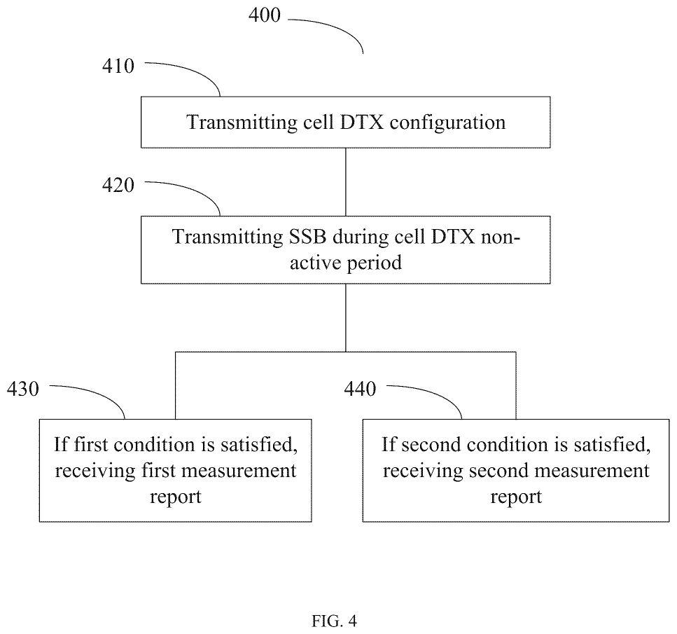

FIG. 4 shows a flow chart illustrating an example method 400 for SSB measurement according to the example embodiments of the present disclosure. The example method 400 may be performed for example by an apparatus for a network device such as the network device 150 above mentioned.

Referring to the FIG. 4, the example method 400 may comprise: an operation 410 of transmitting to a terminal device being served by the network device, a configuration for DTX defining an active period and a non-active period of a cell associated with the network device; an operation 420 of transmitting a SSB during the non-active period and the active period of the cell; an operation 430 of receiving from the terminal device a first measurement report based on a SSB measurement during the non-active period and the active period on the SSB, in case of determining a first condition is satisfied; and an operation 440 of receiving from the terminal device a second measurement report based on the SSB measurement during the active period on the SSB, in case of determining a second condition different from the first condition is satisfied.

Details of the operation 410 have been described in the above descriptions with respect to at least the cell DTX configuration 155, and repetitive descriptions thereof are omitted here.

Details of the operation 420 have been described in the above descriptions with respect to at least the SSB 175, and repetitive descriptions thereof are omitted here.

Details of the operation 430 have been described in the above descriptions with respect to at least the first measurement report 125, and repetitive descriptions thereof are omitted here.

Details of the operation 440 have been described in the above descriptions with respect to at least the second measurement report 135, and repetitive descriptions thereof are omitted here.

In some embodiments, the apparatus may be configured to: transmit to the terminal device, an activation signaling to activate the configuration for the DTX. The more details have been described in the above descriptions with respect to at least the activation signaling 160, and repetitive descriptions thereof are omitted here.

In some embodiments, the configuration for the DTX may comprise parameters used for the DTX, the parameters comprise a periodicity of the DTX, and the second condition may be satisfied in a case where the periodicity of the DTX is equal to or smaller than a threshold. The more details have been described in the above descriptions with respect to at least the cell DTX configuration 155 and the operation 220, and repetitive descriptions thereof are omitted here.

In some embodiments, the apparatus may be configured to: determine a measurement configuration for the terminal device to perform the SSB measurement during the non-active period according to the measurement configuration; and transmit to the terminal device, the measurement configuration to make the first condition satisfied. The more details have been described in the above descriptions with respect to at least the operation 255 and the measurement configuration 260, and repetitive descriptions thereof are omitted here.

In some embodiments, the measurement configuration may comprise a measurement periodicity and a measurement window, and the SSB measurement during the non-active period may be performed according to the measurement periodicity and within the measurement window. The more details have been described in the above descriptions with respect to at least the measurement configuration 260 and the operation 120, and repetitive descriptions thereof are omitted here.

In some embodiments, the measurement configuration may be a measurement configuration of a deactivated SCell. The more details have been described in the above descriptions with respect to at least the measurement configuration 260, and repetitive descriptions thereof are omitted here.

In some embodiments, the measurement configuration may comprise a scaling factor, and the SSB measurement during the non-active period may be performed according to the scaling factor multiplied by a periodicity of the SSB measurement or by the larger between a periodicity of a c-DRX of the terminal device and the periodicity of the SSB measurement. The more details have been described in the above descriptions with respect to at least the SMTC 165, the c-DRX configuration 170, the measurement configuration 260 and the operation 120, and repetitive descriptions thereof are omitted here.

In some embodiments, the apparatus may be configured to receive from the terminal device, a first indication indicating whether the terminal device has capability to support the SSB measurement during the non-active period. The more details have been described in the above descriptions with respect to at least the first indication 215, and repetitive descriptions thereof are omitted here.

In some embodiments, the measurement configuration may be determined in a case where the first indication indicates that the terminal device has capability to support the SSB measurement during the non-active period. The more details have been described in the above descriptions with respect to at least the first indication 215 and the operation 255, and repetitive descriptions thereof are omitted here.

In some embodiments, the apparatus may be configured to: determine the first condition is satisfied in case of receiving from the terminal device, a first indication indicating the terminal device has capability to support the SSB measurement during the non-active period; and receive from the terminal device, the first measurement report based on the SSB measurement during the non-active period and the active period performed according to according to a SMTC. The more details have been described in the above descriptions with respect to at least the first indication 215, the SMTC 165 and the first measurement report 125, and repetitive descriptions thereof are omitted here.

In some embodiments, the apparatus may be configured to: transmit to the terminal device, a second indication indicating whether the terminal device performs the synchronization signal block measurement during at least one following non-active period. The more details have been described in the above descriptions with respect to at least the second indication 265, and repetitive descriptions thereof are omitted here.

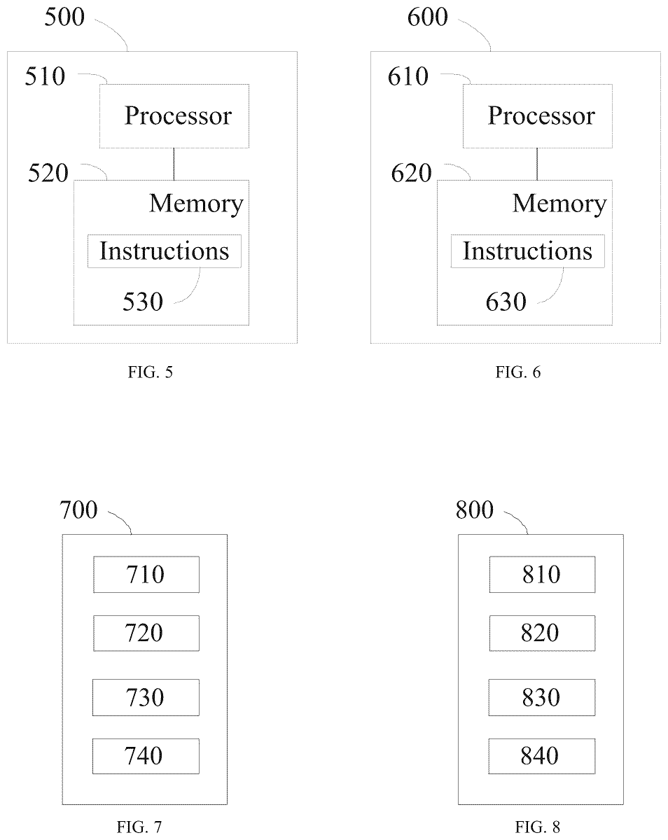

FIG. 5 shows a block diagram illustrating an example device 500 for SSB measurement according to the example embodiments of the present disclosure. The device, for example, may be at least part of an apparatus for a terminal device such as the UE 110 in the above examples.

As shown in the FIG. 5, the example device 500 may include at least one processor 510 and at least one memory 520 that may store instructions 530. The instructions 530, when executed by the at least one processor 510, may cause the device 500 at least to perform the example method 300 described above.

In various example embodiments, the at least one processor 510 in the example device 500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or element not shown in the FIG. 5.

In various example embodiments, the at least one memory 520 in the example device 500 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 520 may include, but are not limited to, an electric, a magnetic, an optical, an electromagnetic, an infrared, or a semiconductor system, apparatus, or device or any combination of the above.

Further, in various example embodiments, the example device 500 may also include at least one other circuitry, element, and interface, for example at least one I/O interface, at least one antenna element, and the like.

In various example embodiments, the circuitries, parts, elements, and interfaces in the example device 500, including the at least one processor 510 and the at least one memory 520, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 500.

FIG. 6 shows a block diagram illustrating an example device 600 for SSB measurement according to the example embodiments of the present disclosure. The device, for example, may be at least part of an apparatus for a network device such as the network device 150 in the above examples.

As shown in the FIG. 6, the example device 600 may include at least one processor 610 and at least one memory 620 that may store instructions 630. The instructions 630, when executed by the at least one processor 610, may cause the device 600 at least to perform the example method 400 described above.

In various example embodiments, the at least one processor 610 in the example device 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example device 600 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 520 may include, but are not limited to, an electric, a magnetic, an optical, an electromagnetic, an infrared, or a semiconductor system, apparatus, or device or any combination of the above.

Further, in various example embodiments, the example device 600 may also include at least one other circuitry, element, and interface, for example at least one I/O interface, at least one antenna element, and the like.

In various example embodiments, the circuitries, parts, elements, and interfaces in the example device 600, including the at least one processor 610 and the at least one memory 620, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 150 is not limited to the above example device 600.

FIG. 7 shows a block diagram illustrating an example apparatus 700 for SSB measurement according to the example embodiments of the present disclosure. The apparatus, for example, may be at least part of a terminal device such as the UE 110 in the above examples.

As shown in the FIG. 7, the example apparatus 700 may comprise: means 710 for receiving, from a network device serving the terminal device, a configuration for DTX defining an active period and a non-active period of a cell associated with the network device; a means 720 for determining whether to perform a SSB measurement during the non-active period based on a first condition and a second condition different from the first condition; a means 730 for based on said determining, if the first condition is satisfied, performing the SSB measurement during the non-active period; and a means 740 for based on said determining, if the second condition is satisfied, refraining from performing the SSB measurement during the non-active period.

In some embodiments, the apparatus 700 may comprise means for receiving from the network device, an activation signaling to activate the configuration for the DTX.

In some embodiments, the configuration for the DTX may comprise parameters used for the DTX, the parameters may comprise a periodicity of the DTX, and the apparatus 700 may comprise means for comparing the periodicity of the DTX with a threshold, and the second condition may be satisfied in a case where the periodicity of the DTX is equal to or smaller than the threshold.

In some embodiments, the threshold may be predefined according to a time period for identifying a cell.

In some embodiments, the apparatus 700 may comprise means for receiving from the network device, a SMTC, or the SMTC and a configuration for c-DRX of the terminal device, and the configuration for the c-DRX may comprise a periodicity of the c-DRX, the SMTC may comprise a periodicity of the SSB measurement, and the threshold may be a number of the periodicity of the SSB measurement, or a number of the larger between the periodicity of the c-DRX and the periodicity of the SSB measurement.

In some embodiments, the first condition may be satisfied in case of receiving a measurement configuration from the network device, and the apparatus may be configured to perform the SSB measurement during the non-active period according to the measurement configuration.

In some embodiments, the measurement configuration may comprise a measurement periodicity and a measurement window, and the SSB measurement during the non-active period may be performed according to the measurement periodicity and within the measurement window.

In some embodiments, the measurement configuration may be a measurement configuration of a deactivated SCell.

In some embodiments, the measurement configuration may comprise a scaling factor, and the SSB measurement during the non-active period may be performed according to the scaling factor multiplied by a periodicity of the SSB measurement or by the larger between a periodicity of a c-DRX of the terminal device and the periodicity of the SSB measurement.

In some embodiments, the apparatus 700 may comprise means for transmitting to the network device, a first indication indicating whether the terminal device has capability to support the SSB measurement during the non-active period.

In some embodiments, the measurement configuration may be received in a case where the first indication indicates that the terminal device has capability to support the SSB measurement during the non-active period.

In some embodiments, the apparatus 700 may comprise means for transmitting to the network device, a first indication indicating whether the terminal device has capability to support the SSB measurement during the non-active period, the first condition may be satisfied in a case where the first indication indicates that the terminal device has capability to support the SSB measurement during the non-active period, and the apparatus may be configured to perform the SSB measurement during the non-active period according to a SMTC.

In some embodiments, the apparatus 700 may comprise means for receiving from the network device, a second indication indicating whether the terminal device performs the SSB measurement during at least one following non-active period, and performing the SSB measurement during the at least one following non-active period may be determined in a case where the second indication indicates the terminal device to perform the SSB during the at least one following non-active period.

In some example embodiments, examples of means in the example apparatus 700 may include circuitries. For example, an example of means 710 may include a circuitry configured to perform the operation 310 of the example method 300, an example of means 720 may include a circuitry configured to perform the operation 320 of the example method 300, an example of means 730 may include a circuitry configured to perform the operation 330 of the example method 300, and an example of means 740 may include a circuitry configured to perform the operation 340 of the example method 300.

The example apparatus 700 may further include means comprising circuitry configured to perform the example method 300. In some example embodiments, examples of means may also include software modules and any other suitable function entities.

FIG. 8 shows a block diagram illustrating an example apparatus 800 for SSB measurement according to the example embodiments of the present disclosure. The apparatus, for example, may be at least part of a network device such as the network device 150 in the above examples.

As shown in the FIG. 8, the example apparatus 800 may comprise: means 810 for transmitting to a terminal device being served by the network device, a configuration for DTX defining an active period and a non-active period of a cell associated with the network device; means 820 for transmitting a SSB during the non-active period and the active period of the cell; means 830 for receiving from the terminal device a first measurement report based on a SSB measurement during the non-active period and the active period on the SSB, in case of determining a first condition is satisfied; and means 840 for receiving from the terminal device a second measurement report based on the SSB measurement during the active period on the SSB, in case of determining a second condition different from the first condition is satisfied.

In some embodiments, the apparatus 800 may comprise means for transmitting to the terminal device, an activation signaling to activate the configuration for the DTX.

In some embodiments, the configuration for the DTX may comprise parameters used for the DTX, the parameters comprise a periodicity of the DTX, and the second condition may be satisfied in a case where the periodicity of the DTX is equal to or smaller than a threshold.

In some embodiments, the apparatus 800 may comprise means for determining a measurement configuration for the terminal device to perform the SSB measurement during the non-active period according to the measurement configuration; and means for transmitting to the terminal device, the measurement configuration to make the first condition satisfied.

In some embodiments, the measurement configuration may comprise a measurement periodicity and a measurement window, and the SSB measurement during the non-active period may be performed according to the measurement periodicity and within the measurement window.

In some embodiments, the measurement configuration may be a measurement configuration of a deactivated SCell.

In some embodiments, the measurement configuration may comprise a scaling factor, and the SSB measurement during the non-active period may be performed according to the scaling factor multiplied by a periodicity of the SSB measurement or by the larger between a periodicity of a c-DRX of the terminal device and the periodicity of the SSB measurement.

In some embodiments, the apparatus 800 may comprise means for receiving from the terminal device, a first indication indicating whether the terminal device has capability to support the SSB measurement during the non-active period.

In some embodiments, the measurement configuration may be determined in a case where the first indication indicates that the terminal device has capability to support the SSB measurement during the non-active period.

In some embodiments, the apparatus 800 may comprise means for determining the first condition is satisfied in case of receiving from the terminal device, a first indication indicating the terminal device has capability to support the SSB measurement during the non-active period; and the apparatus may be configured to receive from the terminal device, the first measurement report based on the SSB measurement during the non-active period and the active period performed according to according to a SMTC.

In some embodiments, the apparatus 800 may comprise means for transmitting to the terminal device, a second indication indicating whether the terminal device performs the synchronization signal block measurement during at least one following non-active period.

In some example embodiments, examples of means in the example apparatus 800 may include circuitries. For example, an example of means 810 may include a circuitry configured to perform the operation 410 of the example method 400, an example of means 820 may include a circuitry configured to perform the operation 420 of the example method 400, an example of means 830 may include a circuitry configured to perform the operation 430 of the example method 400, and an example of means 840 may include a circuitry configured to perform the operation 440 of the example method 400.

The example apparatus 800 may further include means comprising circuitry configured to perform the example method 400. In some example embodiments, examples of means may also include software modules and any other suitable function entities.

The example embodiments of the present disclosure also provide a computer readable medium comprising program instructions that, when executed by an apparatus for a terminal device such as the UE 110 in the above examples, may cause the terminal device at least to: receive, from a network device serving the terminal device, a configuration for DTX defining an active period and a non-active period of a cell associated with the network device; determine whether to perform a SSB measurement during the non-active period based on a first condition and a second condition different from the first condition; based on said determining, if the first condition is satisfied, perform the SSB measurement during the non-active period; and based on said determining, if the second condition is satisfied, refrain from performing the SSB measurement during the non-active period.

In some embodiments, the computer readable medium may include instructions that, when executed by the apparatus, may cause the terminal device to: receive from the network device, an activation signaling to activate the configuration for the DTX.

In some embodiments, the configuration for the DTX may comprise parameters used for the DTX, the parameters may comprise a periodicity of the DTX, and the computer readable medium may include instructions that, when executed by the apparatus, may cause the terminal device to compare the periodicity of the DTX with a threshold, and the second condition may be satisfied in a case where the periodicity of the DTX is equal to or smaller than the threshold.

In some embodiments, the threshold may be predefined according to a time period for identifying a cell.

In some embodiments, the computer readable medium may include instructions that, when executed by the apparatus, may cause the terminal device to receive from the network device, a SMTC, or the SMTC and a configuration for c-DRX of the terminal device, and the configuration for the c-DRX may comprise a periodicity of the c-DRX, the SMTC may comprise a periodicity of the SSB measurement, and the threshold may be a number of the periodicity of the SSB measurement, or a number of the larger between the periodicity of the c-DRX and the periodicity of the SSB measurement.

In some embodiments, the first condition may be satisfied in case of receiving a measurement configuration from the network device, and the computer readable medium may include instructions that, when executed by the apparatus, may cause the terminal device to perform the SSB measurement during the non-active period according to the measurement configuration.

In some embodiments, the measurement configuration may comprise a measurement periodicity and a measurement window, and the SSB measurement during the non-active period may be performed according to the measurement periodicity and within the measurement window.

In some embodiments, the measurement configuration may be a measurement configuration of a deactivated SCell.

In some embodiments, the measurement configuration may comprise a scaling factor, and the SSB measurement during the non-active period may be performed according to the scaling factor multiplied by a periodicity of the SSB measurement or by the larger between a periodicity of a c-DRX of the terminal device and the periodicity of the SSB measurement.

In some embodiments, the computer readable medium may include instructions that, when executed by the apparatus, may cause the terminal device to: transmit to the network device, a first indication indicating whether the terminal device has capability to support the SSB measurement during the non-active period.

In some embodiments, the measurement configuration may be received in a case where the first indication indicates that the terminal device has capability to support the SSB measurement during the non-active period.

In some embodiments, the computer readable medium may include instructions that, when executed by the apparatus, may cause the terminal device to transmit to the network device, a first indication indicating whether the terminal device has capability to support the SSB measurement during the non-active period, the first condition may be satisfied in a case where the first indication indicates that the terminal device has capability to support the SSB measurement during the non-active period, and the computer readable medium may include instructions that, when executed by the apparatus, may cause the terminal device to perform the SSB measurement during the non-active period according to a SMTC.

In some embodiments, the computer readable medium may include instructions that, when executed by the apparatus, may cause the terminal device to receive from the network device, a second indication indicating whether the terminal device performs the SSB measurement during at least one following non-active period, and performing the SSB measurement during the at least one following non-active period may be determined in a case where the second indication indicates the terminal device to perform the SSB during the at least one following non-active period.

The example embodiments of the present disclosure also provide a computer readable medium comprising program instructions that, when executed by an apparatus for a network device such as the network device 150 in the above examples, may cause the network device at least to: transmit to a terminal device being served by the network device, a configuration for DTX defining an active period and a non-active period of a cell associated with the network device; transmit a SSB during the non-active period and the active period of the cell; receive from the terminal device a first measurement report based on a SSB measurement during the non-active period and the active period on the SSB, in case of determining a first condition is satisfied; and receive from the terminal device a second measurement report based on the SSB measurement during the active period on the SSB, in case of determining a second condition different from the first condition is satisfied.

In some embodiments, the computer readable medium may include instructions that, when executed by the apparatus, may cause the network device to transmit to the terminal device, an activation signaling to activate the configuration for the DTX.

In some embodiments, the configuration for the DTX may comprise parameters used for the DTX, the parameters comprise a periodicity of the DTX, and the second condition may be satisfied in a case where the periodicity of the DTX is equal to or smaller than a threshold.

In some embodiments, the computer readable medium may include instructions that, when executed by the apparatus, may cause the network device to determine a measurement configuration for the terminal device to perform the SSB measurement during the non-active period according to the measurement configuration; and transmit to the terminal device, the measurement configuration to make the first condition satisfied.

In some embodiments, the measurement configuration may comprise a measurement periodicity and a measurement window, and the SSB measurement during the non-active period may be performed according to the measurement periodicity and within the measurement window.

In some embodiments, the measurement configuration may be a measurement configuration of a deactivated SCell.

In some embodiments, the measurement configuration may comprise a scaling factor, and the SSB measurement during the non-active period may be performed according to the scaling factor multiplied by a periodicity of the SSB measurement or by the larger between a periodicity of a c-DRX of the terminal device and the periodicity of the SSB measurement.

In some embodiments, the computer readable medium may include instructions that, when executed by the apparatus, may cause the network device to receive from the terminal device, a first indication indicating whether the terminal device has capability to support the SSB measurement during the non-active period.

In some embodiments, the measurement configuration may be determined in a case where the first indication indicates that the terminal device has capability to support the SSB measurement during the non-active period.

In some embodiments, the computer readable medium may include instructions that, when executed by the apparatus, may cause the network device to determine the first condition is satisfied in case of receiving from the terminal device, a first indication indicating the terminal device has capability to support the SSB measurement during the non-active period; and receive from the terminal device, the first measurement report based on the SSB measurement during the non-active period and the active period performed according to according to a SMTC.

In some embodiments, the computer readable medium may include instructions that, when executed by the apparatus, may cause the network device to transmit to the terminal device, a second indication indicating whether the terminal device performs the synchronization signal block measurement during at least one following non-active period.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the above description, the terms “terminal device”, “communication device”, “terminal”, “user equipment” and “UE” may be used interchangeably.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
c-DRX connected discontinuous reception
DCI downlink control information
DRX discontinuous reception
DTX discontinuous transmission
MAC medium access control
NES network energy saving
NW network
PBCH physical broadcast channel
PDCCH physical downlink control channel
RRC radio resource control
SCell secondary cell
SSB synchronization signal block synchronization signal and PBCH block
SMTC SSB-based measurement timing configuration
UE user equipment

What is claimed is:

1. An apparatus for a terminal device, comprising:
at least one processor; and
at least one memory storing instructions that, when executed by the at least one processor, cause the terminal device at least to:
receive, from a network device serving the terminal device, a configuration for discontinuous transmission defining an active period and a non-active period of a cell associated with the network device;
determine whether to perform a synchronization signal block measurement during the non-active period based on a first condition and a second condition different from the first condition;
based on said determining, if the first condition is satisfied, perform the synchronization signal block measurement during the non-active period; and
based on said determining, if the second condition is satisfied, refrain from performing the synchronization signal block measurement during the non-active period.

2. The apparatus of claim 1, wherein the apparatus is configured to:
receive from the network device, an activation signaling to activate the configuration for the discontinuous transmission.

3. The apparatus of claim 1, wherein the configuration for the discontinuous transmission comprise parameters used for the discontinuous transmission, the parameters comprise a periodicity of the discontinuous transmission, and
wherein the apparatus is configured to:
compare the periodicity of the discontinuous transmission with a threshold, and
the second condition is satisfied in a case where the periodicity of the discontinuous transmission is equal to or smaller than the threshold.

4. The apparatus of claim 3, wherein the threshold is predefined according to a time period for identifying a cell.

5. The apparatus of claim 3, wherein
the apparatus is configured to receive from the network device, a synchronization signal block measurement timing configuration, or the synchronization signal block measurement timing configuration and a configuration for connected discontinuous reception of the terminal device, and
the configuration for the connected discontinuous reception comprises a periodicity of the connected discontinuous reception, the synchronization signal block measurement timing configuration comprises a periodicity of the synchronization signal block measurement, and the threshold is a number of the periodicity of the synchronization signal block measurement, or a number of the larger between the periodicity of the connected discontinuous reception and the periodicity of the synchronization signal block measurement.

6. The apparatus of claim 1, wherein the first condition is satisfied in case of receiving a measurement configuration from the network device, and the apparatus is configured to perform the synchronization signal block measurement during the non-active period according to the measurement configuration.

7. The apparatus of claim 6, wherein the measurement configuration comprises a measurement periodicity and a measurement window, and the synchronization signal block measurement during the non-active period is performed according to the measurement periodicity and within the measurement window.

8. The apparatus of claim 6, wherein the measurement configuration is a measurement configuration of a deactivated secondary cell.

9. The apparatus of claim 6, wherein the measurement configuration comprises a scaling factor, and the synchronization signal block measurement during the non-active period is performed according to the scaling factor multiplied by a periodicity of the synchronization signal block measurement or by the larger between a periodicity of a connected discontinuous reception of the terminal device and the periodicity of the synchronization signal block measurement.

10. The apparatus of claim 6, wherein the apparatus is configured to:
transmit to the network device, a first indication indicating whether the terminal device has capability to support the synchronization signal block measurement during the non-active period.

11. The apparatus of claim 10, wherein the measurement configuration is received in a case where the first indication indicates that the terminal device has capability to support the synchronization signal block measurement during the non-active period.

12. The apparatus of claim 1, wherein
the apparatus is configured to transmit to the network device, a first indication indicating whether the terminal device has capability to support the synchronization signal block measurement during the non-active period,
the first condition is satisfied in a case where the first indication indicates that the terminal device has capability to support the synchronization signal block measurement during the non-active period, and
the apparatus is configured to perform the synchronization signal block measurement during the non-active period according to a synchronization signal block measurement timing configuration.

13. The apparatus of claim 1, wherein
the apparatus is configured to receive from the network device, a second indication indicating whether the terminal device performs the synchronization signal block measurement during at least one following non-active period, and
performing the synchronization signal block measurement during the at least one following non-active period is determined in a case where the second indication indicates the terminal device to perform the synchronization signal block measurement during the at least one following non-active period.

14. An apparatus for a network device, comprising:
at least one processor; and
at least one memory storing instructions that, when executed by the at least one processor, cause the network device at least to:
transmit to a terminal device being served by the network device, a configuration for discontinuous transmission defining an active period and a non-active period of a cell associated with the network device;
transmit a synchronization signal block during the non-active period and the active period of the cell;
receive from the terminal device a first measurement report based on a synchronization signal block measurement during the non-active period and the active period on the synchronization signal block, in case of determining a first condition is satisfied; and
receive from the terminal device a second measurement report based on the synchronization signal block measurement during the active period on the synchronization signal block, in case of determining a second condition different from the first condition is satisfied.

15. The apparatus of claim 14, wherein the apparatus is configured to:
transmit to the terminal device, an activation signaling to activate the configuration for the discontinuous transmission.

16. The apparatus of claim 14, wherein the apparatus is configured to:
determine a measurement configuration for the terminal device to perform the synchronization signal block measurement during the non-active period according to the measurement configuration; and
transmit to the terminal device, the measurement configuration to make the first condition satisfied,
wherein the measurement configuration comprises a measurement periodicity and a measurement window, and the synchronization signal block measurement during the non-active period is performed according to the measurement periodicity and within the measurement window, and
wherein the measurement configuration is a measurement configuration of a deactivated secondary cell.

17. The apparatus of claim 16, wherein
the apparatus is configured to receive from the terminal device, a first indication indicating whether the terminal device has capability to support the synchronization signal block measurement during the non-active period, wherein the measurement configuration is determined in a case where the first indication indicates that the terminal device has capability to support the synchronization signal block measurement during the non-active period.

18. The apparatus of claim 14, wherein the apparatus is configured to:
determine the first condition is satisfied in case of receiving from the terminal device, a first indication indicating the terminal device has capability to support the synchronization signal block measurement during the non-active period; and
receive from the terminal device, the first measurement report based on the synchronization signal block measurement during the non-active period and the active period performed according to according to a synchronization signal block measurement timing configuration.

19. The apparatus of claim 14, wherein the apparatus is configured to:
transmit to the terminal device, a second indication indicating whether the terminal device performs the synchronization signal block measurement during at least one following non-active period.

20. A method performed by an apparatus for a terminal device, comprising:
receiving, by the terminal device from a network device serving the terminal device, a configuration for discontinuous transmission defining an active period and a non-active period of a cell associated with the network device;
determining, by the terminal device, whether to perform a synchronization signal block measurement during the non-active period based on a first condition and a second condition different from the first condition;
based on said determining, by the terminal device if the first condition is satisfied, performing the synchronization signal block measurement during the non-active period; and
based on said determining, by the terminal device if the second condition is satisfied, refraining from performing the synchronization signal block measurement during the non-active period.
